(19) United States
(12) Patent Application Publication
(10) Pub. No.: US 2012/0253902 A1
(43) Pub. Date: Oct. 4, 2012

(54) LOCATION BASED MARKETING

(76) Inventor: Conrad R. Carney, II, Lexington, KY (US)

(21) Appl. No.: 13/435,115

(22) Filed: Mar. 30, 2012

Related U.S. Application Data
(60) Provisional application No. 61/470,753, filed on Apr. 1, 2011.

(51) Int. Cl. G06Q 30/02

(52) U.S. Cl. 705/14.12; 705/14.58; 705/14.27

(57) ABSTRACT

A location based marketing method includes steps for receiving a participating customer location, comparing that customer location to a list of participating vendor locations, initiating a vendor check-in procedure if the customer location corresponds to a participating vendor location and initiating a map displaying participating vendor locations within a predetermined distance of the customer location if the participating customer location does not correspond to a participating vendor location.

This utility patent application claims the benefit of U.S. Provisional Patent Application Ser. No. 61/470,753 filed on 1 Apr. 2011, the entirety of the disclosure of which is incorporated herein by reference.

### TECHNICAL FIELD

This document relates generally to games and applications and more particularly to an integrated location-based marketing system and method that is computer implemented.

### BACKGROUND

This document relates to an interactive, social media marketing media platform or integrated location based marketing system that allows local and national businesses to market to consumers using IIM (Integrated Interactive Marketing), to help build their consumer base. The system uses a custom-built mobile app that can run, for example, on consumers smart phones to allow them to locate local and national businesses that are close to their location and earn rewards by visiting them.

Local businesses, and national businesses with a local presence, can use this system to reach consumers in their areas. This system promotes these businesses when customers are physically close to their location. By using “Location Based Marketing” to help target customers in a geographical area, a business is able to capitalize on the number of new customers gained and to turn those customers into repeat buyers.

This system includes a one-stop marketing site for both businesses and consumers. This system can be accessed through traditional channels such as, laptop, netbook, smartphone, electronic reader, cell phone, personal digital assistant, tablet computer, handheld computing device, personal computer, etc. via the mobile app.

Business owners are becoming more concerned with the time and expense of monitoring the social media through multiple channels. This system also provides businesses with a way to automatically update their Facebook page and Twitter feed with their latest deals from a single, web-based portal.

### SUMMARY

A location-based marketing method comprises: receiving, by a computing device or server, a participating customer location from a mobile communication device of the participating customer, comparing, by the computing device, the participating customer location to a list of participating list of vendor locations, if the participating customer location corresponds to one of the participating vendor locations, initiating, by the computing device, a vendor check-in procedure on the mobile communication device of the participating customer and if the participating customer location does not correspond to one of the participating vendor locations, initiating, by the computing device, a map displaying participating vendor locations within the predetermined distance of the participating customer location.

The check-in procedure includes initiating, by the computing device, displaying of a vendor promotional video on the mobile communication device of the participating customer and a vendor threshold reward status including displaying of any currently earned reward or remaining requirement to earn the next reward. Further the check-in procedure includes updating, by the computing device, the game status of the participating customer visiting the participating vendor location. In addition the method includes initiating, by the computing device, a marketing game played by the participating customer.

In accordance with an additional aspect a non-transitory machine readable storage medium comprises instructions that, when executed by one or more processors of the machine, cause the machine to perform operations comprising: receiving a participating customer location from a mobile communication device of the participating customer; comparing the participating customer location to a list of participating vendor locations; if the participating customer locations corresponds to one of the participating vendor locations, initiating a vendor check-in procedure on the mobile communication device of the participating customer; and if the participating customer location does not correspond to one of the participating vendor locations, initiating a map displaying participating vendor locations within a predetermined distance of the participating customer location.

In addition, an apparatus comprises: an interface to communicate with participating customers of a location-based marketing game; a memory to store data associated with the location-based marketing game; and at least one processor coupled to the interface and the memory. The at least one processor is configured to: receive a participating customer location from a mobile communication device of the participating customer; compare the participating customer location to a list of participating vendor locations; initiate a vendor check-in procedure on the mobile communication device of the participating customer if the participating customer location corresponds to one of the participating vendor locations; and initiate a map displaying participating vendor locations within a predetermined distance of the participating customer location if the participating customer location does not correspond to one of the participating vendor locations.

### BRIEF DESCRIPTION OF THE DRAWING FIGURES

The accompanying drawing figures incorporated herein and forming a part of the specification, illustrate several aspects of the computer implemented method of location based marketing and together with the description serve to explain certain principles thereof. In the drawings:

FIG. 1 is a block diagram of an exemplary system for implementing the location based marketing method and rewards program;

FIG. 2 is a block diagram of an exemplary computing device usable in the system illustrated in FIG. 1;

FIG. 3 is a block diagram illustrating various communication portals to the game system;

FIG. 4 is a flow diagram exemplary of the location based marketing game;

FIG. 5A is a flow diagram exemplary of a vendor check-in procedure;

FIG. 5B is an illustration of an exemplary user interface for vendor check-in on a mobile communication device of a participating customer;

FIG. 6A is a flow diagram exemplary of a method of providing a participating customer with information about vendors having vendor locations within a predetermined distance of the customer location;

FIG. 6B is an illustration of an exemplary user interface for providing a customer with information about vendors having vendor locations within a predetermined distance of the customer location; and

FIGS. 7A-7D are a continuous series of flow diagrams illustrating a location based marketing game and reward program.

Reference will now be made in detail to the present preferred embodiment of the location based marketing method and reward program, an example of which are illustrated in the accompanying drawings.

### DETAILED DESCRIPTION OF THE INVENTION

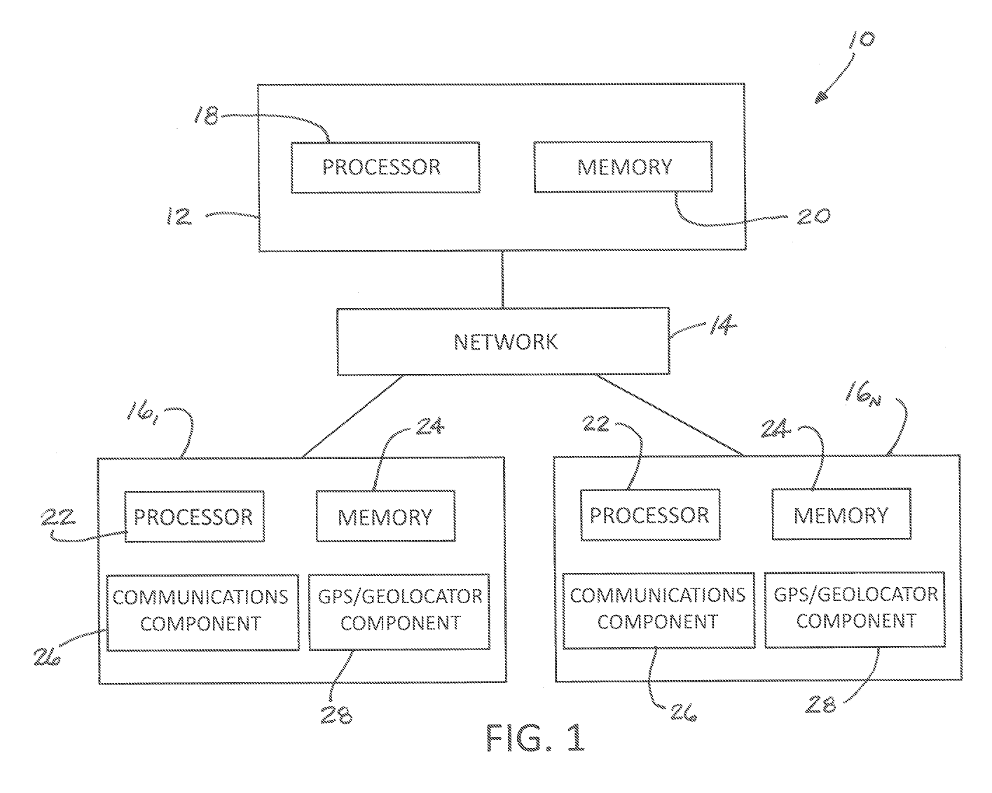

Reference is now made to FIG. 1 illustrating the computing system environment 10 which may comprise a computing device, base unit or computing device 12 that communicates over a network 14 with a mobile communication device 16₁. Typically, the computing device 12 communicates with multiple mobile communication devices schematically illustrated as 16₁-16_{N}. The computing device 12 may include a processor 18 and a memory 20. The memory 20 may be utilized to store, for example, instructions that cause the processor 18 to perform various tasks and steps of the novel location-based marketing game described in detail below. The memory 20 may also be utilized to store, for example, a list of participating vendor locations, vendor promotional videos, vendor threshold reward status, game status, vendor deals or offers and the like.

Each mobile communication device 16₁, 16_{N} may include a processor 22, a memory 24, a communications component 26 and a GPS/geolocator component 28. The memory 24 may be utilized to store a mobile app including instructions that when executed by the processor 22, cause the mobile communication device 16₁, 16_{N} to operate in accordance with any function described herein. For example, memory 24 may include instructions for viewing a vendor video, redeeming a vendor threshold reward or selecting a master game reward as described in greater detail below.

The communications component 26 interfaces with the processor 22 and facilitates wired or wireless communication with external systems such as the computing device 12 over the network 14. The network 14 may comprise any network of a type known in the art including but not limited to a local area network (LAN), a wide area network (WAN), a wireless network or any other network or network of networks including that generally known as the internet. The GPS/geolocator component 28 may include a location app of a type known in the art. Alternatively, or in addition, the GPS/geolocator component 28 may include a global positioning system (GPS) receiver. Regardless of its configuration the GPS/geolocator component 28 is capable of accurately identifying the geographic position of the mobile communication device 16₁, 16_{N} being utilized by the participating customer of the location-based marketing system.

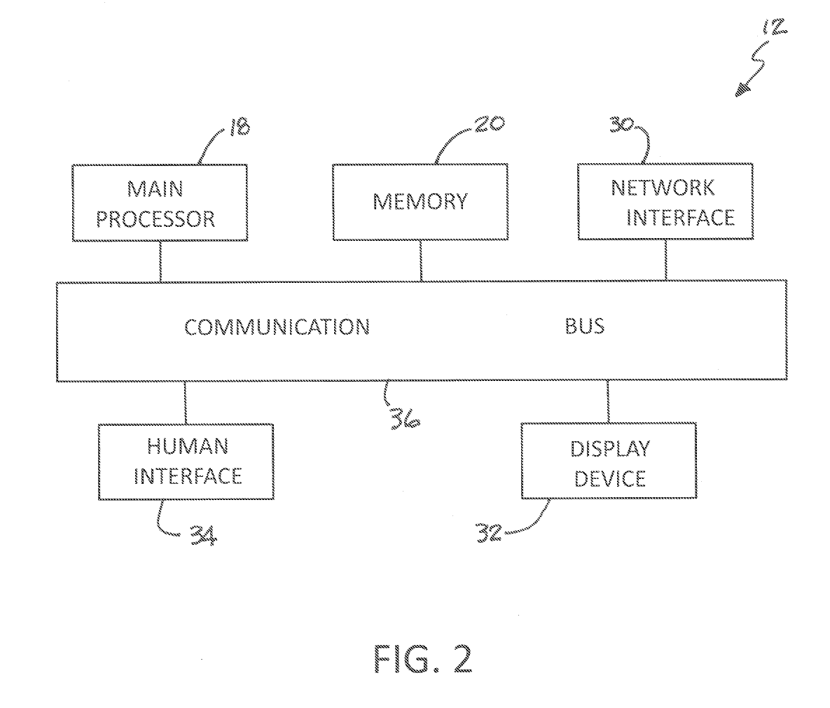

Reference is now made to FIG. 2 illustrating the computing system environment 10 including the computing device, base unit or computing device 12. As illustrated the computing device 12 includes one or more processors 18 and one or more memories 20. The computing system environment 10 also includes one or more network interfaces 30 and one or more input/output devices such as display devices 32 and human interfaces 34. As should be appreciated, all of these components communicate with each other over a communications bus 36.

In one particularly useful embodiment, the computing device 12 takes the form of a server. It should be appreciated, however, that substantially any computing device having a processor can be utilized. Thus, the computing device 12 may also take the form of a laptop, digital assistant, tablet computer, personal computer, or other computing device able to execute computer readable instructions.

The processor 18 may be referred to as a main processor or central processing unit (CPU). The processor 18 may include a single or multiple processing cores. Where two or more cores are provided, the cores may be capable of operating in parallel.

The memory 20 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 18 accesses the memory 20 through the communications bus 36 to access any application or data stored thereon including, but not limited to, any computer readable instructions.

The network interface 30 may be used to interface with any network 14 including but not limited to the internet. The input/output devices may comprise one or more computer monitors, printers or other display devices 32 as well as human interfaces 34 including but not limited to keyboards, mice, pointers, microphones, speakers or the like.

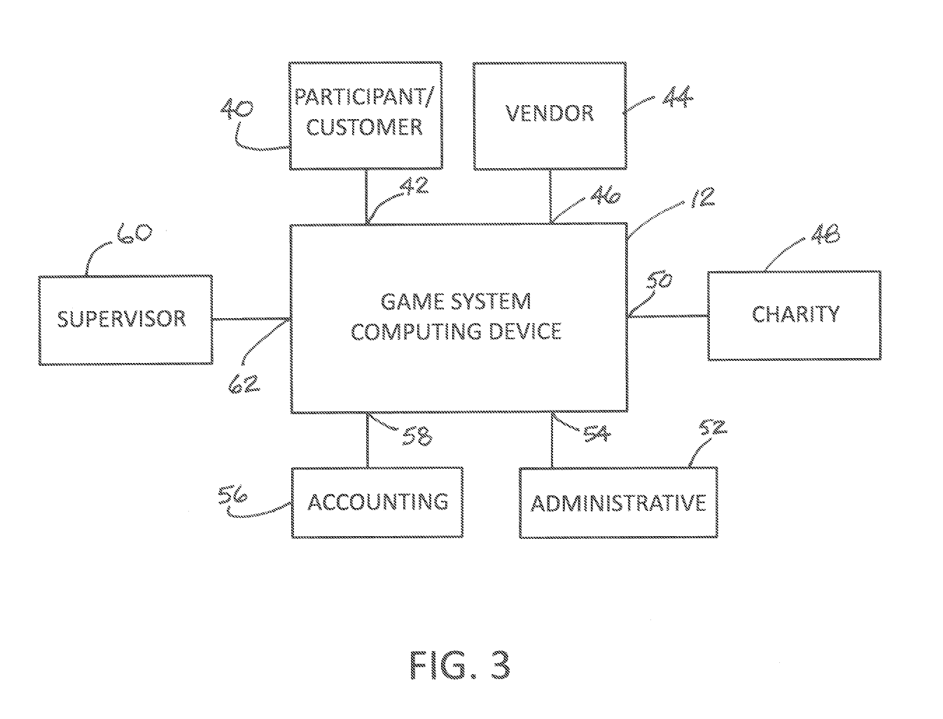

As illustrated in FIG. 3, the game system computing device 12 may be accessed by six different classes of users. More specifically, the participant customer user 40 accesses the computing device 12 through the participant customer access port 42. The vendor user 44 accesses the computing device 12 through the vendor access port 46. A charity user 48 may access the computing device 12 through the charity access port 50. An administrative user 52 may access the computing device 12 through an administrative port 54. An accounting user 56 may access the computing device 12 through the accounting port 58. Finally, a superuser 60 may access the computing device 12 through a superuser port 62. A participant customer user 40 is able to register, download, configure and use the location-based marketing game, interact with areas of the related website that are only accessible to logged in users, play the game, buy special vendor deals and reap vendor rewards through their mobile communication device 16₁, 16_{N}. Vendor users 44 are duly authorized representatives of participating vendors, including restaurants and retailers that use the vendor port 46 to upload and manage the various deals they are offering to the participant customers. Vendor users 44 will also be able to review reports on user participation, dollar amounts sold and dollar amounts paid as part of the prepaid deal portion of the application. The vendor port 46 also allows the vendor user 44 to upload and schedule promotional videos viewed by participant users on their mobile communication devices 16₁, M_{N} upon check in. Other account maintenance functions are also accessed by the vendors 44 through the vendor port 46.

A charity 48 may receive monitory donations in exchange for participant user's participation in the various promotions. Through the charity port 50 a charity user 48 may invite participant customers to participate in their charitable program as well as view various reports on a number of users and dollar amounts earned and paid through the system. A charity user 48 may also edit and maintain contact info and accounting info about the charity through the charity access port 50.

Administrative users 52, such as customer support and sales reps of the location-based marketing company offering the game, may access computing device 12 through the administrative access port 54 so as to manage all aspects of users, vendors, charities, deals, banner ads and other functions such as user comments and the customer support knowledge base. Administrative personnel 52 utilizing the administrative port 50 also have access to the vendor and charity ports 46, 50 so that they may assist participant, vendor and charity users 40, 44, 48 with any issues they may be encountering with system operation and functions.

Accounting personal 56 may access the computing device 12 through the accounting access port 58 to gain access to accounting functions within the system that should not be available to customer support or sales people. Accounting personnel 56 utilizing this port 58 would typically be responsible for paying vendors and charities for their participation in any prepaid deal and gift card portions of the system. Such users 56 will also be able to review reports showing money owed as well as statements showing when and how much has been paid to vendors and charities. The accounting personnel 56 will also be able to review sales activity reports for prepaid deals and gift card sales.

Superusers 60 will be able to access the computing device 12 through the superuser access port 62 and thereby have rights and permission to all other user ports 42, 46, 50, 54, 58 for system wide access and activity such as sales, products sold, banner ad revenue, sponsored deal revenue and other data needed for executive management of the business.

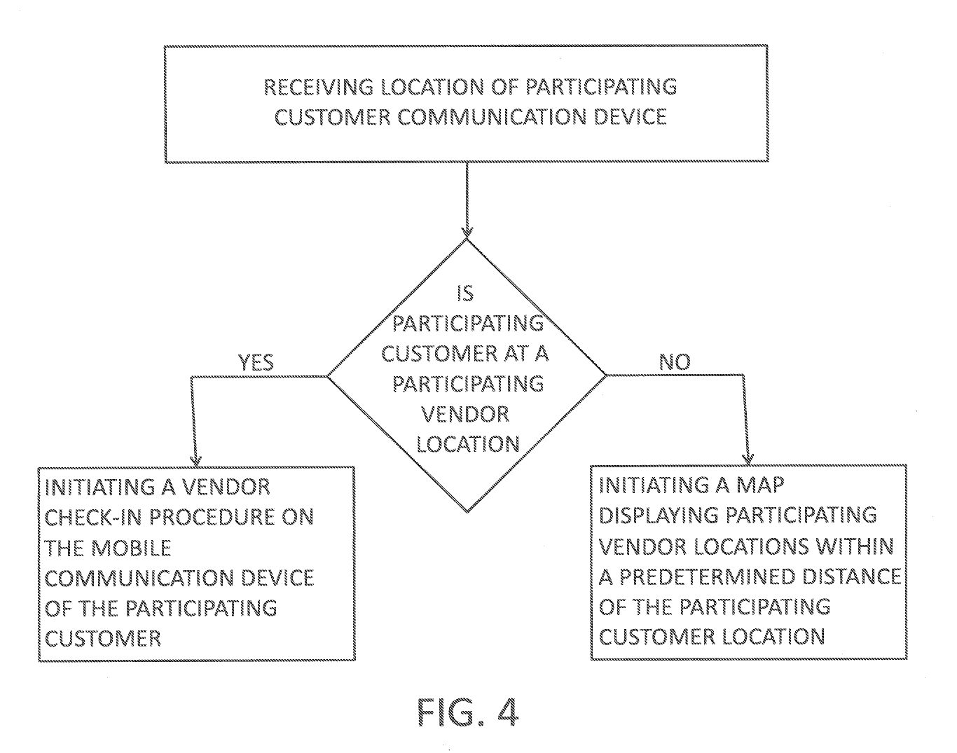

As illustrated in FIG. 4, the location-based marketing method may be generally described as comprising: receiving, by a computing device 12, a participating location from a mobile communication device 16₁, 16_{N} of a participating customer and comparing, by the computing device 12, the participating customer location to a list of participating vendor locations. If the participating customer location corresponds to one of the participating vendor locations, the method includes the step of initiating, by the computing device 12, a vendor check-in procedure on the mobile communication device 16₁, 16_{N} of the participating customer. In contrast, if the participating customer location does not correspond to one of the participating vendor locations, the method includes initiating, by the computing device 12, a map displaying participating vendor locations within a predetermined distance of said participating customer location.

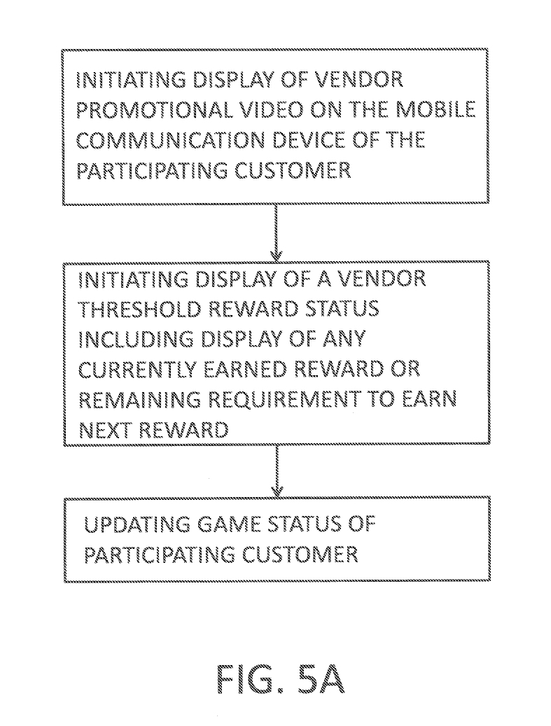

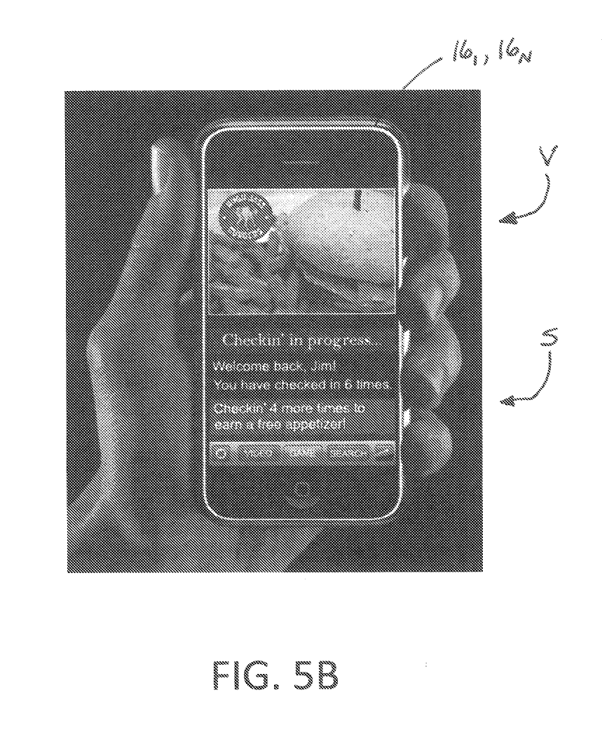

As illustrated in FIG. 5A, the check-in procedure includes initiating, by the computing device 12, displaying of a vendor promotional video on the mobile communication device 16₁, 16_{N} of the participating customer. Such a video may inform the customer about new vendor products or services, offer the customer special deals, thank the customer for visiting the vendor or do anything else which may promote the business of the vendor. The check-in procedure may also include initiating, by the computing device 12, displaying of a vendor threshold reward status including displaying of any currently earned reward or remaining requirement to earn the next reward. In addition, the check-in procedure may further include updating by the computing device 12, game status of the participating customer visiting the participating vendor location. FIG. 5B illustrates a mobile communication device 16₁, 16_{N}, in the form of a smartphone, cycling through the check-in procedure including a display of the promotional video V and a display of the threshold reward status S.

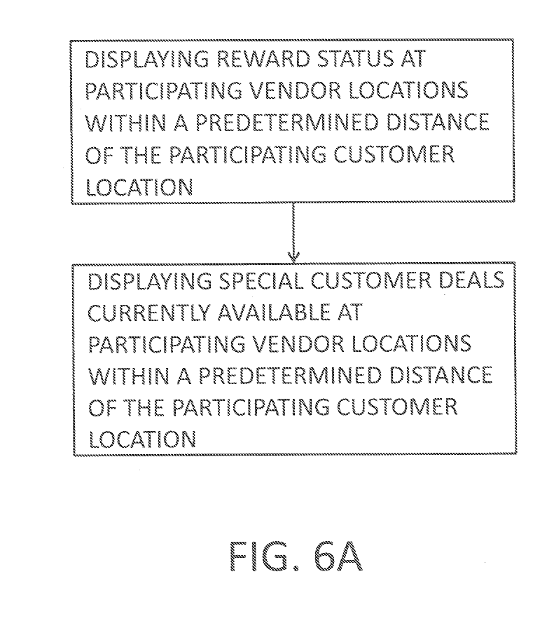

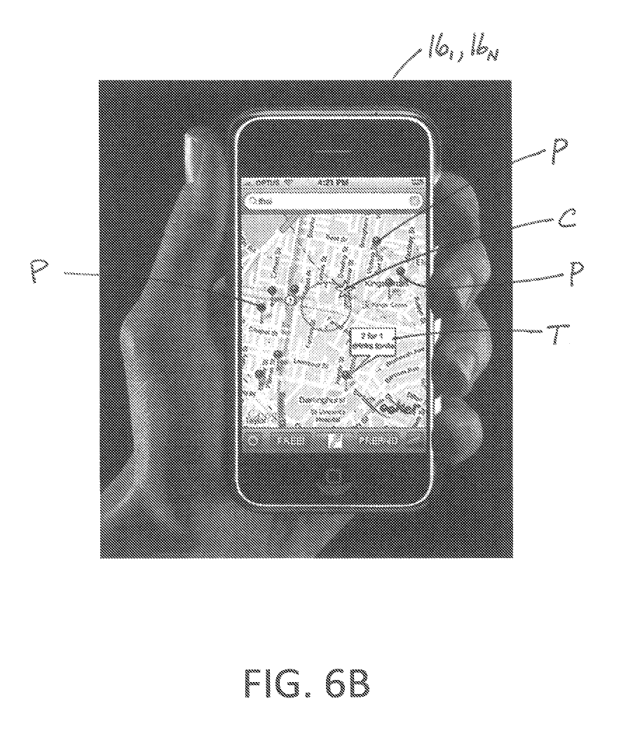

As illustrated in FIG. 6A, where the participating location does not correspond with the one of the participating vendor locations a vendor location map is displayed. It should be appreciated that the map also displays reward status of participating vendor locations within a predetermined distance of the participating customer location and special customer deals currently available at participating vendor locations within a predetermined distance of the participating customer location. FIG. 6B illustrates a mobile communication device 16₁, 16_{N} of a participating customer in this mode of operation showing a map centered on the participating customer's location and displaying “pushpins” P to indicate participating vendor locations within a predetermined distance (such as two miles) of the participating customer location. Different colored stars or chests C indicate any reward the participating customer will earn by visiting a particular participating vendor location and call outs (note text balloon T) display a sponsored deal of the day at a particular customer location.

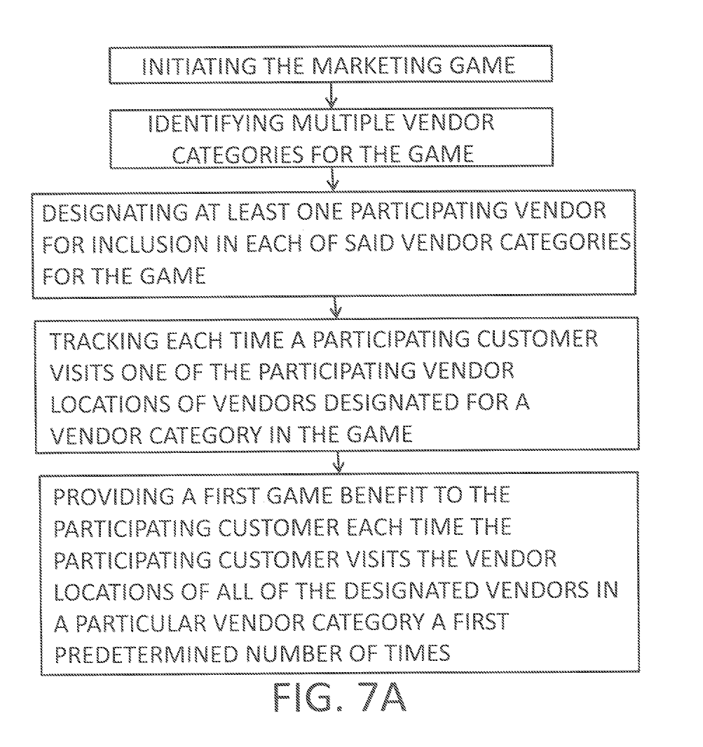

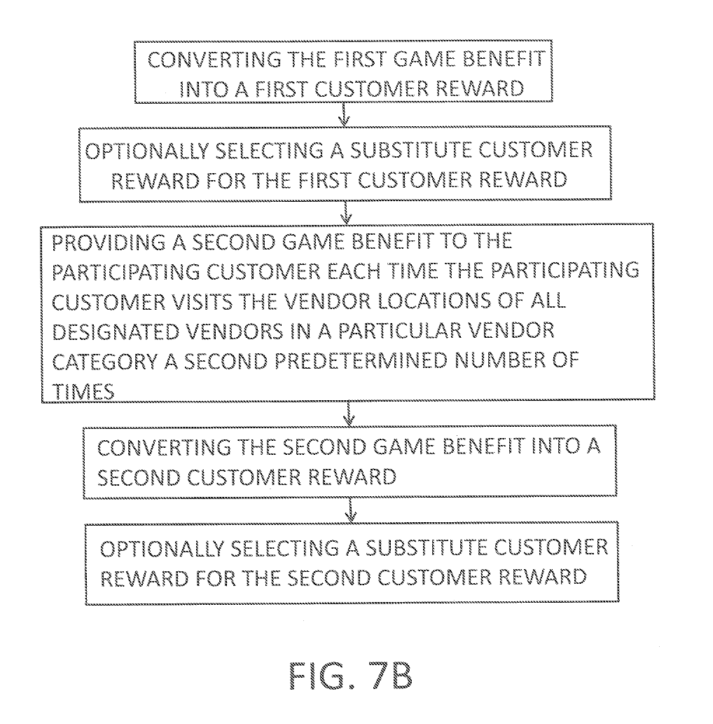

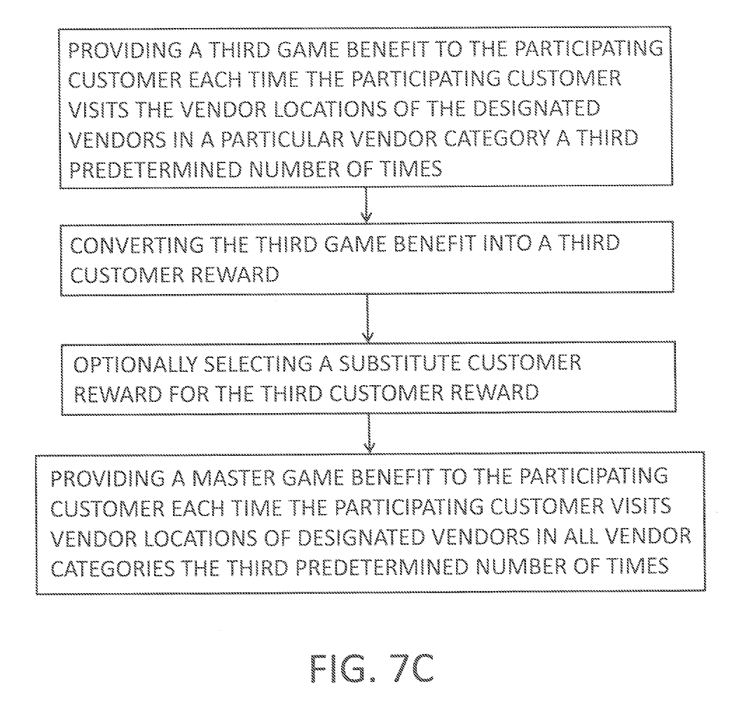

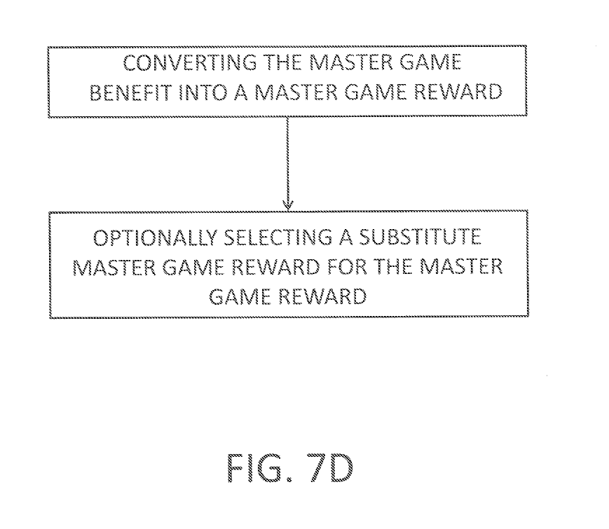

At any time a participating customer may utilize his mobile communication device 16₁, 16_{N} to communicate with the computing device 12 and thereby initiate, by the computing device, a marketing game to be played by the participating customer. Alternatively, the marketing game may be initiated automatically on the participating customer's mobile communication device 16₁, 16_{N} by the computing device 12 after, for example, the computing device updates the game status of the customer. FIGS. 7A-7D are a continuous series of figures that illustrate the various steps of this marketing game. Those steps include identifying multiple vendor categories for the game. Substantially any categories may be utilized including, for example, national restaurant chains, local restaurants, national retailers and local retailers. Next the participant user uses his mobile communication device 16₁, 16_{N} or another computing device such as a laptop or personal computer to communicate with the game system computing device 12 and designates by the computing device 12, at least one participating vendor for inclusion in each of the vendor categories for the game. The computing device 12 tracks, by communication with the mobile communication device 16₁, 16_{N} each time a participating customer visits one of the participating vendor locations of vendors designated for a vendor category in the game and provides a first game benefit to the participating customer each time the participating customer visits the vendor locations of all the designated vendors in a particular vendor category a first predetermined number of times (for example, three times). The game method further includes converting by the computing device 12, the first game benefit into a first customer reward. The game then includes an optional step allowing the participating customer to select a substitute customer reward for the first customer reward should the customer so desire. The game also provides, by the computing device 12, a second game benefit to the participating customer each time the participating customer visits the vendor locations of all designated vendors in a particular vendor category a second predetermined number of times (for example, six times). This is followed by the converting, by the computing device 12, of the second game benefit into a second customer reward. Once again, the participating customer then has the optional step of selecting a substitute customer reward for the second customer reward if the customer so desires.

This is then followed by the step of providing a third game benefit to the participating customer each time the participating customer visits the vendor locations of the designated vendors in a particular vendor category a third predetermined number of times (for example, nine times). This is followed by the converting of the third game benefit into a third customer reward. Once again the participant customer is then provided with the optional step of selecting a substitute customer reward for the third customer reward.

Finally, the game method includes providing, by the computing device 12, a master game benefit to the participating customer each time the participating customer visits vendor locations of the designated vendors in all vendor categories for a predetermined number of times such as the third predetermined number of times previously mentioned. This is followed by the converting, by the computing device 12, of the master game benefit into a master game reward for the participant customer. The participant customer may then optionally select a substitute master game reward if desired.

The following example further illustrates and details the location based marketing game. As should be appreciated, however, this example is illustrative in nature and not limiting in scope.

### Example 1

### The XOOKer Game

XOOKer is an interactive game consumers play on their mobile phone to win prizes at their favorite restaurants and stores. To play, consumers download the XOOKer app to their mobile device 16₁, 16_{N} and register for their account. The game consists of four rows. Each row is based on the type of business, national retailer, national restaurant, local retailer and local restaurant. Each row contains four squares, each square containing a restaurant or retail location. When a consumer checks in at a participating business they are awarded a star (bronze, silver, or gold, based on the number of times the user has checked in at that location). By accumulating enough stars, a user is awarded the key to a treasure chest containing a prize. The user advances through the game by visiting a location of each of the participating retailers. At the end of each level there is a grand prize. There are multiple levels. XOOKer Points can also be earned through the game.

Although the game is primarily a mobile experience, the user can configure the game and view their game status through the website.

XOOKer Mobile App

The XOOKer mobile app is a key component in the XOOKer game but has other features as well. Mobile users play the game by checking in while visiting participating businesses. The mobile app uses geo-location to identify the user's location and automatically updates their status within the XOOKer game. Users can also view the XOOKer “Deal of the Day” offered by the business, or buy the XOOKer “Prepaid Deal” for that business. The mobile app also has the ability to search for deals offered by all participating businesses by category and/or location, and gives the user the ability to view and maintain his/her account status.

The XOOKer mobile app will synchronize with a user's Twitter and Facebook accounts. XOOKer users have the option to use their Twitter or Facebook accounts to register, check-in with, and can optionally, automatically tweet or update their Facebook status every time they check-in at a participating business.

XOOKer Deals

XOOKer will have the ability to send featured deals and promotions to customers via their mobile device 16₁, 16_{N} and the XOOKer website, allowing them to find participating retailers and restaurants that are close to their present location. Users can also sign-up for the XOOKer Newsletter, which delivers email deals and up-to-date news on what's happening with XOOKer in their desired area and categories of interest.

XOOKer will offer two distinctly different types of deals to consumers. First, the XOOKer Prepaid Deal will typically be a minimum of 50% off the standard price of the item being promoted. Consumers will be able to select prepaid offers from specific categories and receive them via the mobile app or email. Second, the XOOKer Daily Deals offers “Free Daily Deals” to consumers. Businesses will post daily deals that consumers will not have to pre-purchase. Offers will be valid for a limited time and can be posted and managed directly by the vendor or business. Consumers can access these offers through the XOOKer website or XOOKer mobile app. Consumers who request offers by category will receive them only in the areas of interest they pre-selected. One daily deal in each category will be sent to the consumer each day, with the other deals being accessed through the website or via the mobile app. Consumers will be able to select which type of offers they are shown when they search for deals using the XOOKer app on their mobile phone. Consumers will be able to search for businesses and offers within a specific geographical area (city, zip code or within a 2 mile radius of their location).

XOOKer Checkin'

Every time the user visits a participating business, the XOOKer Checkin' portion of the mobile app automatically checks the user in and updates their game status. It then plays a short promotional video provided by the vendor or business they are currently visiting. Then, the user will be shown any alerts triggered by their latest check-in, and information about the special deals offered by the business.

XOOKer Checkin' also allows a participating business to award special promotions for initial check-ins or for a particular number of check-ins (i.e. every 5^{th}, 10^{th} or 15^{th} check-in, etc.)

XOOKer Mobile Rewards

XOOKer Mobile Rewards is a loyalty program for retail and restaurant clients. Restaurants & retailers can designate the value of the reward points or dollars that consumers can earn with the items or dollar amounts purchased. XOOKer points are awarded based on the total amount spent at the business' locations or on specific items purchased. XOOKer will track the loyalty rewards to verify the amount spent at the restaurant/retail location. The point of sale terminals will print a bar code at the bottom of each receipt that will contain the amount of the ticket and the date and time of the visit. Additionally what was ordered/purchased will be contained in the bar code. XOOKer mobile loyalty reward points for retail and restaurant clients can be used in conjunction with current rewards programs. Consumers will be able to track their loyalty rewards for each business either online at XOOKer.com or via their mobile phone 16₁, 16_{N}.

XOOKer Points

Consumers can earn XOOKer points when they purchase pre-paid XOOKer Deals or gift cards. Points will also be earned when existing members invite friends to join XOOKer. Other methods of earning points will be through the XOOKer loyalty reward game, as well as mobile entertainment games that will be hosted on XOOKer. Points can be used by consumers to receive additional discounts when purchasing XOOKer pre-paid deals and gift cards.

Additional Details of the XOOKer Game and XOOKer Checkin'

Game Logic

To play, users download the XOOKer app to their mobile device 16₁, 16_{N} and register their account. They will then be prompted to invite friends from their contact list as well as their social media sites, which will earn them XOOKer points.

The game board has 4 sections (rows) each with 4 columns:

1) National Restaurants

2) Local Restaurants

3) National Retailers

4) Local Retailers

Once a user creates an account, he or she browses a list of national and local restaurants as well as national and local retailers they would like to place on their game board. They select 4 businesses/locations from each section. For example, in Section 1 for National Restaurants, they could choose; TGI Fridays, iHop, Denny's, & Longhorn Steakhouse. Then, when the user visits one of the restaurants or retailers they have listed on their game board, they check in using the Checkin' function on the XOOKer mobile app (which is automatic, if the user doesn't opt out during installation and configuration of the mobile app, otherwise the user needs to tap a button to initiate the Checkin' process). The app uses geolocation to verify that the user is in fact at a participating business. Each of their Checkin's earns the user a XOOKer star and advances them towards earning the coveted XOOKer Keys, which are used to unlock deal lockers and prize chests.

Stars and prizes are earned as follows:
1 Check-In at one of their selected locations=1 XOOKer Star
4 XOOKer Stars (1 Check-In at each location per section)=1 XOOKer Bronze Key
8 XOOKer Stars (2 Check-In at each location per section)=1 XOOKer Silver Key
12 XOOKer Stars (3 Check-In at each location per section)=1 XOOKer Gold Key
XOOKer Keys (Bronze, Silver and Gold) from each section=1 XOOKer Master Key

When the user has won all 12 XOOKer keys, meaning they have visited each of their 16 chosen locations 3 times each, they will receive the Master Key.

For the following example we will use the National Retailers section. The user will select 4 national retailers from the list of participating businesses. These national retailers have locations in the geographical area where the user is shopping. When initially configuring the game, this user selected Target, Macy's, American Eagle and Best Buy. When the user visits one the participating stores or restaurants (in this example, Target) they check in using the XOOKer app on their phone. Using geolocation, the XOOKer system confirms which participating Target location at which the user is located. Next, a short 15 to 30 second promotional video (selected and pre-loaded into the system by Target) plays on the users' phone. In order for the user to receive the XOOKer points and stars for this check in, the video must be viewed in its entirety. After the video completes, the mobile app displays any games alerts that may have been triggered by the user's latest check-in. For example, if the user has visited three out of the four businesses they selected in any row, the system will pop up an alert saying they only need to visit the remaining business to earn their next Key. The app would also update the user's Facebook status and/or Twitter feed, if the user had selected those functions when installing and configuring their game.

After the user has visited each of the selected national retailers once (Target, Macy's, American Eagle and Best Buy) they will automatically receive a Bronze Key. Upon receiving the Bronze Key the user can advance to the Treasure Chest portion of the game. The user can click on the icon and play the game instantly on their mobile phone or choose to play it later on their PC, laptop or other computing device. In this Treasure Chest portion of the game, the player selects one of three Bronze Treasure Chests. The user will have the choice of Chest #1, Chest #2 or Chest #3. In this example the user selects Chest #1. The chest opens and reveals a prize, for example, a 5% discount on their next purchase from Target. The user now has a choice. They can keep the prize from Chest #1 or they can trade it in for the chance to open one of the remaining chests. The user only gets to trade one time during any prize round. This means one chest will remain unopened every round.

The prizes awarded will be from one of the four businesses in that section. The user will continue to the Silver round and then to the Gold round for each section. This means the user has visited each business in each section at least 3 times. The users will receive XOOKer points for each additional visit to their selected businesses after the 3^{rd} check-in for each level. This will entice the user to continue visiting businesses even after they have received all three stars (bronze, silver & gold) for this level.

Once the user has reached the Gold level on all 4 sections they will receive the Master Key and the opportunity to select from three Grand prize treasurer chests. The Grand prize will have a significantly higher value than those of the sectional rounds. Once again, the user will have the choice of Chest #1, Chest #2 or Chest #3. In this example, the user selects Chest #1 and the chest opens and reveals a prize. The user now has a choice. They can keep the prize from Chest #1 or they can trade it in for the chance to select one of the remaining chests. At this point, the user will have completed and mastered Level 1.

The XOOKer game will encompass multiple levels that the user can achieve. At each new level the user will have the option to choose new restaurants and retailers for their game board. The value of each Gold Round Master Key (Grand Prize) will be greater than the prior level. This too will give incentive to the users to continue to play XOOKer and receive valuable prizes such as gift cards and trips. Higher levels will have 1 to 2 pre-selected businesses in each category which businesses will pay a premium to insure increased user traffic. Users will be willing to try new locations because of the opportunity to win more valuable prizes.

XOOKer Checkin'

There is component of the system separate from the game, where people earn points simply for checking with a participating business. The business offers rewards for achieving certain number of Checkin's.

Checkin' rewards can be tallied one of two ways. First, a reward can be earned for every 10 (or whatever number the vendor chooses) Checkin's. The vendor also chooses the reward earned.

The second method is by total number of Checkin's. The vendor has the option to set up to five levels of rewards, the number of total Checkin's required to earn the reward at each level, and the reward earned. After the user earns the highest reward, the system resets and they start over.

Each type of promotion can be programmed to start and end on pre-defined dates. There is a maximum of one Checkin' per location per day.

XOOKer Loyalty Rewards

Loyalty Rewards are based on number of dollars spent. The participating vendor or business is able to set the dollar amounts necessary to earn each reward and what the reward is.

The XOOKer Mobile App

The XOOKer Mobile App is the primary method for user interaction with the XOOKer system. Through this app, users receive deal alerts, view and purchase Deals, check-in when visiting a participating location, view their XOOKer game status, refer friends and manage their XOOKer accounts.

The operation of the mobile app is as automatic as possible, and takes advantage of geolocation to the greatest practical extent. Based on the user's location, the mobile app automatically selects one of two modes. If the user is at a participating business' location, the app automatically enters Checkin mode (see FIG. 5B). If the user is not at a participating location, the app displays a map of the user's current location (See FIG. 6B). This map displays pushpins indicating participating businesses within a 2 mile radius. There is also a Search Deals function, a XOOKer Game function and a My Account function which are not based on geolocation. These modes and functions are described in more detail below.

The following features represent the minimum functionality necessary to achieve full system functionality.

### Download Mobile App

The app is available for download via the Apple App Store, Android Marketplace, or some other convenient location that is easily accessible from the user's mobile device 16₁, 16_{N}.

Install the App

The app has a simple, intuitive installer which guides the user through installation and configuration.

Configure the App

The following options are configured in order for the app to be usable with the XOOKer system:

Enter, or Otherwise Determine, the User's Email Address.

Email address is necessary in order to send the user alerts and deal information. In one possible embodiment, the configuration utility automatically pulls the user's email address from information stored in the user's mobile device and pre-fill the email address field, giving the user the opportunity to change it.

Enter the User's Home City, State, Zip Code and Preferred Categories.

This information is necessary to select and display XOOKer deals on the website that are based on the user's home location, and if geolocation data is not available, on the user's mobile device 16₁, 16_{N}. In one possible embodiment, this information should be pulled automatically from the user's mobile device 16₁, 16_{N} and the fields are pre-filled, giving the user the opportunity to update them.

Choose Alert Categories

Deals are separated into Categories, which are then used to ensure the users only get updates on products and promotions that are of interest to them. Alerts are sent to the user on a regular basis either through email or directly to the user's mobile device via the XOOKer app.

Choose Alert Preferences
Opt in to the email alerts sent daily to the user's email address
Opt in to the mobile alerts sent daily to the user's cell phone
Opt in to messages sent via the mobile app which alert the user of what they have to do to achieve the next reward. For example, “Visit any Target location to earn a key to the Treasure Chest.”

There will be an “Advanced” feature where users can select individual business locations whose alerts will always be sent.

Option to Automatically Update the User's Facebook Status or Tweet, Saying that they're Visiting the Participating XOOKer Business.

If the user selects either or both of these options, the mobile app automatically updates the user's Facebook status and/or Twitter feed with a message about the business the user is visiting.

Option to Send Invitations to the User's Contacts and/or Facebook Friends or Twitter Followers.

The user has the option to send an invitation to the contacts in the user's mobile device, or to their Facebook friends or Twitter followers and earn points for each accepted/registered invitation. The system tracks all invitations through the registration process and provides a report (available via the superuser port 62) showing how many invitations were sent out and how many resulted in new user registrations.

Setup the Game Board and Choose Vendors

This step is necessary in order to play the XOOKer game. It is accessed during installation and each time a user completes a level of the game by visiting all 16 locations (three times each) on the game board. At that point in the game the user is able to choose new retailers and locations for the next level.

Configuration Data is Transmitted Securely to the XOOKer Servers

User information entered into the mobile device 16₁, 16_{N} is transmitted to the XOOKer computing devices or servers 12 via a secure connection.

Search for a Business

The user can type keywords into the Search Box and the system will return matching businesses with the user's current metropolitan area. The search routine will search: Keywords, Vendor's Name, Street Address and Categories.

Advanced Browse/Search

The user can browse or search for participating businesses outside of the current geographical area by any combination of Keywords, Category selection or Geographical location by City and State or Zip Code.

View Game Board and Game Status

This function displays the Game Board, showing all of the locations the user had visited and which round (Bronze, Silver or Gold) the user is at for that location. It also displays XOOKer point totals and any alerts telling the user when they're close to achieving the next prize.

View XOOKer “Free Deal of the Day”

The “Free Deal of the Day” is displayed according to the following priority. If the current location has a deal loaded into the system, it is displayed. If there is no Free Deal for the current location and the location is part of a national chain, the system searches for a Free Deal entered by the national retailer or restaurant. If no deal is found, the system displays the XOOKer Sponsored Deal for the day.

View and Purchase XOOKer “Prepaid Deal of the Day”

The “Prepaid Deal” is displayed according to the following priority. If the current location has a deal loaded into the system, it is displayed. If there is no Prepaid Deal for the current location and the location is part of a national chain, the system searches for a Prepaid Deal entered by the national retailer or restaurant. If there is no deal for the retailer or restaurant the prepaid deal for the zip code is displayed. If there is no such deal, the deal for the city is displayed. If nothing comes up the app displays a message like “No participating businesses in your area”, with options to view all deals in your area or all deals.

Search for and Purchase Free, Prepaid and Sponsored Deals by Category and/or Location

The user has the option to view (and purchase, if applicable) all deals in the system by category and/or location, not just those displayed on the mobile map showing the user's present location. The user has the ability to change the zoom level.

Buy a XOOKer Gift Card (Future Version)

Users are able to purchase Gift Cards of various types from their mobile device 16₁, 16_{N}.

Send to a Friend

The user has the option to send any deal viewed by the user to a friend. The system tracks and logs each time a deal is sent to a friend.

Edit Account Info and Preferences

This feature gives the user the ability to edit their information and preferences. This is separate from game configuration.

View Banner Ads

Several screens of the app will have an area where banners ads from the XOOKer inventory are displayed.

Website Component

The XOOKer website will allow users to view, search for and purchase XOOKer deals. Users can also sign up to participate in XOOKer promotions, set up their XOOKer Game Board, view their game status, leave comments, refer friends and manage their XOOKer accounts and purchase gift cards.

The various embodiments set forth herein are described in terms of exemplary block diagrams, flow charts and other illustrations. As will become apparent to those skilled in the art, the illustrated embodiments and their various alternatives can be implemented without confinement to the illustrated examples. Thus, the block diagrams, flow charts, all drawing figures and their accompanying description should not be construed as mandating a particular architecture or configuration.

What is claimed:

1. A location-based marketing method, comprising:
receiving, by a computing device, a participating customer location from a mobile communication device of said participating customer;
comparing, by said computing device, said participating customer location to a list of participating vendor locations;
if said participating customer location corresponds to one of said participating vendor locations, initiating by said computing device a vendor check-in procedure on said mobile communication; and
if said participating customer location does not correspond to one of said participating vendor locations, initiating by said computing device, a map displaying participating vendor locations within a predetermined distance of said participating customer location.

2. The method of claim 1 wherein said check-in procedure includes initiating, by said computing device, displaying of a vendor promotional video on said mobile communication device of said participating customer.

3. The method of claim 1, wherein said check-in procedure includes initiating, by said computing device, displaying of a vendor threshold reward status including displaying of any currently earned reward or remaining requirement to earn next reward.

4. The method of claim 1 wherein said check-in procedure includes initiating, by said computing device, displaying of a vendor promotional video on said mobile communication device of said participating customer and initiating, by said computing device, displaying of a vendor threshold reward status including displaying of any currently earned reward or remaining requirement to earn next reward.

5. The method of claim 1 wherein said check-in procedure includes updating, by said computing device, game status of said participating customer visiting said participating vendor location.

6. The method of claim 5, further including initiating, by said computing device, a marketing game played by said participating customer.

7. The method of claim 6, further including identifying, by said computing device, multiple vendor categories for said game.

8. The method of claim 7 further including designating, by said computing device, at least one vendor for inclusion in each of said vendor categories for said game.

9. The method of claim 8, further including tracking, by said computing device, each time said participating customer visits one of said vendor locations of said vendors designated for said game.

10. The method of claim 9, further including providing, by said computing device, a first game benefit to said participating customer each time said participating customer visits said vendor locations of all of said designated vendors in a particular vendor category a first predetermined number of times.

11. The method of claim 10, further including converting, by said computing device, said first game benefit into a first customer reward.

12. The method of claim 11, further including selecting, by said computing device, a first substitute customer reward for said first customer reward.

13. The method of claim 10, further including providing, by said computing device, a second game benefit to said participating customer each time said participating customer visits said vendor locations of all said designated vendors in a particular vendor category a second predetermined number of times.

14. The method of claim 13, further including converting, by said computing device, said second game benefit into a second customer reward.

15. The method of claim 14, further including selecting, by said computing device, a second substitute customer reward for said second customer reward.

16. The method of claim 13, further including providing, by said computing device, a third game benefit to said participating customer each time said participating customer visits said vendor locations of all said designated vendors in a particular vendor category a third predetermined number of times.

17. The method of claim 16, further including converting, by said computing device, said third game benefit into a third customer reward.

18. The method of claim 17, further including selecting, by said computing device, a third substitute customer reward for said third customer reward.

19. The method of claim 16, further including providing, by said computing device, a master game benefit to said participating customer each time said participating customer visits vendor locations of said designated vendors in all vendor categories said third predetermined number of times.

20. The method for claim 19, further including converting, by said computing device, said master game benefit into a master customer reward.

21. A non-transitory machine readable storage medium comprising instructions that, when executed by one or more processors of a machine, cause the machine to perform operations, comprising:
receiving a participating customer location from a mobile communication device of said participating customer;
comparing said participating customer location to a list of participating vendor locations;
if said participating customer locations corresponds to one of said participating vendor locations, initiating a vendor check-in procedure on said mobile communication device of said participating customer; and
if said participating customer location does not correspond to one of said participating vendor locations, initiating a map displaying participating vendor locations within a predetermined distance of said participating customer location.

22. An apparatus, comprising:
an interface to communicate with participating customers of a location-based marketing game;
a memory to store data associated with said location-based marketing game;
at least one processor coupled to said interface and said memory, said at least one processor configured to:
receive a participating customer location from a mobile communication device of said participating customer;
compare said participating customer location to a list of participating vendor locations;
if said participating customer location corresponds to one of said participating vendor locations, initiate a vendor check-in procedure on said mobile communication device of said participating customer; and
if said participating customer location does not correspond to one of said participating vendor locations, initiate a map displaying participating vendor locations within a predetermined distance of said participating customer location.
